(19) United States
(12) Patent Application Publication
(10) Pub. No.: US 2016/0096705 A1
(43) Pub. Date: Apr. 7, 2016

(54) Fish Tape Adaptor for Powered Retraction of the Fish Tape

(71) Applicant: Jonathan Ryals, Shelbyville, TX (US)

(72) Inventor: Jonathan Ryals, Shelbyville, TX (US)

(21) Appl. No.: 14/866,972

(22) Filed: Sep. 27, 2015

Related U.S. Application Data
(60) Provisional application No. 62/058,627, filed on Oct. 1, 2014.

(51) Int. Cl. B65H 75/44; B65H 75/40; F16D 1/00

(52) U.S. Cl. CPC B65H 75/4481; F16D 1/00; B65H 75/406; F16D 2300/12; B65H 2701/376

(57) ABSTRACT

A side reel adaptor for a fish tape reel allows the fish tape reel to be spun with a drill. In one embodiment, the side reel adapter includes an attachment plate and a central bit. The attachment plate includes a plurality of holes that are aligned with the screw holes of one or more fish tape reels so that the attachment plate can be attached to the side of the one or more fish tape reels using the screws of the one or more fish tape reels. The central bit is connected to the center of the attachment plate so that the central bit is perpendicular to the attachment plate. The central bit is adapted to accept a drill chuck so that a drill can spin attachment plate about the axis of the central bit and, in turn, spin the fish tape reel attached to the attachment plate.

### CROSS-REFERENCE TO RELATED APPLICATION

This application claims the benefit of U.S. Provisional Patent Application No. 62/058,627 filed Oct. 1, 2014.

### INTRODUCTION

Fish tape is used in many trades to pull wire through a conduit. In order to do this, one first pushes a narrow metal strip, or tape, through the conduit. The wire is then attached to the extended end of the metal tape and the metal tape is then retracted through the conduit, pulling the wire through the conduit as well.

Modern fish tapes devices often incorporate a reel such that the fish tape is wound around the reel by manually rotating the reel about a handle. More specifically, the reel is formed as a flattened ring-shaped rotatable body having a slot formed all the way around its outer circumference. The reel is usually formed in two generally mirror-image halves that fit together so as to create an interior space for storing the fish tape. The reel has an inner hub on which the fish tape is wound. The free end of the fish tape having the loop attachment extends through the outer slot in the reel. The handle is attached to the reel to facilitate grasping the device while the fish tape is extended and reeled in. As stated above, the reel can rotate relative to the handle to pay out or reel in the fish tape. This is accomplished by positioning the handle to engage the outer slot such that the handle can slide along the slot. However, the fish tape is drawn through the conduit by hand, either by pulling the fish tape itself, or by grasping the reel and turning it to wind the fish tape onto the reel.

One problem with current fish tape devices is that it is very difficult to pull lengthy amounts of wire or string through the conduit. In particular, on long runs of conduit such as often found in a commercial building, several electricians or other workers may be required to manually pull the wire or string through the conduit. Such a procedure is often inefficient, fatiguing, and potentially dangerous. To compound the problem, conventional manually-operated fish tape devices require that the fish tape then be wound about the reel, which wastes valuable time and energy of the electrician.

To address the above-mentioned problems, powered fish tape devices have been developed in which the fish tape is stored within the confines of the device and controllably payed out and reeled in by a drive motor so that the fish tape travels through the conduit until it extends from the free end thereof, where a wire is attached to the end of the fish tape and then drawn through the conduit by reeling the fish tape back into the device. Such a device is disclosed in U.S. Pat. No. 4,917,362. Powered fish tape devices, however, typically include a high number of parts and a sophisticated series of gears, both of which involve high complexity and cost. Furthermore, these devices typically employ their own integrated motors, thus having no adaptability or interoperability with existing fish tape devices.

Still other devices have been developed that address the above-mentioned problems by providing an attachment for existing fish tape devices that enable a user to manually reel the fish tape into the fish tape device. For example, the 2003 patent issued to Yates, U.S. Pat. No. 6,513,791, describes an attachment for existing fish tape devices. The Yates device utilizes a central hub to rotate the case while the handle is held stationary to either extend or retract the fish tape. However, it has been shown that a central drive for such a reeling device is prone to breaking due to the large stresses that may come to bear when reeling in a long length of metal tape. This feature also negates the normal operation of the hand-held tool.

Referring FIG. 1, a fish tape apparatus is represented generally by the numeral 10. The apparatus 10 comprises a housing or reel 12 which is formed from a pair of ring-shaped members 12a, 12b held together by adhesives or fasteners, such as screws 18. The ring-shaped members 12a, 12b are positioned to define a slot 14 extending around the reel 12 between the ring-shaped members. A handle 16 is slidably attached to the reel 12 by engagement in the slot 14 such that the reel 12 can be moved relative to the handle 16 and rotated about central axis 15 while holding the handle 16. The reel 12 defines a central opening 13 therein.

The fish tape 22 comprises a resiliently flexible metal or plastic tape or cord and includes loop attachment wires 26 at a distal end 24. The distal end 24 of the fish tape 22 extends from the reel 12 through the slot 14 and is fed into a conduit for attachment to wires or other bodies, such as string, to be pulled back through the conduit. The fish tape 22 wound about the reel 12 is contained between the ring-shaped members 12a, 12b and is capable of being payed out and reeled in by rotating the reel 12 about the central axis 15 while maintaining the handle 16 in a stationary position. In particular, the handle 16 is held by an operator such that the reel 12 slides along the slot 14 relative to the handle 16, allowing the tape to be payed out or reeled into the apparatus 10. However, manually rotating the reel 12 relative to the handle 16 when reeling in the tape can be tiresome, laborious, and inefficient.

Yates includes a center drive device 28 for automatically reeling in the fish tape 22 about the reel 12. In one embodiment, the center drive device 28 is an attachment for an existing fish tape apparatus and is secured within the central opening 13 of the reel 12. The center drive device 28 includes a body portion 30 that is sized slightly larger than the central opening 13 such that the outer edge 40 of the body portion 30 frictionally secures the center drive device 28 to the inner edge 42 of the central opening 13 of the reel, such as by an interference or snap fit. In the embodiment shown in FIG. 2, the body portion 30 has a generally square configuration as does the central opening 13 of the reel. Thus, the center drive device 28 can be pressed into place within the central opening 13 in a plane parallel to the slot 14. The center drive device 28 can later be removed by pressing the center drive device with sufficient force to overcome the interference or frictional fit between the edges 40 of the body portion 30 and the edges 42 of the reel 12 defined by the central opening 13.

The center drive device 28 also includes at least one drive fitting 32 extending away from the body portion 30. The drive fitting 32 is attached to the body portion 30 of the center drive device 28 at the central axis 15 via a bolt 36 extending through the body portion 30. Advantageously, the drive fittings 32, 34 of the center drive device 28 are provided for engagement with a powered driver, such as a hex nut driver or power drill 37. The handle 16 is held stationary relative to the rotating reel 12, such that the handle slides along the slot 14. The rotation of the reel causes the fish tape 22 to be reeled in and wound about the reel 12, thereby simultaneously pulling a wire or other flexible elongate object through the conduit, thus saving valuable time to the operator.

Yates also provides alternative where the center drive device 28 is formed integrally with the reel 12. For example, the body portion of the center drive device and one of the ring-shaped members 12a or 12b of the reel 12 can be formed as a one-piece construction, such as by injection-molding or the like. Yates also provides spoked version of the center drive device 28.

The invention of Yates, however, has at least four problems. First, the attachment embodiment appears difficult to secure and, as described above, is likely to wobble under higher speeds and continued use. Second, the center drive device 28 completely fills central opening 13, preluding its use in manual retraction. Third, a different center drive device 28 has to be used for each different type and size of fish tape reel, since the central opening 13 varies among types and sizes of fish tape reels. Four, integrally forming center drive device 28 requires modification of existing reels.

### BRIEF DESCRIPTION OF THE DRAWINGS

FIG. 1 is a diagram of a prior art fish tape reel apparatus including a center drive device.

FIG. 2 is a top view of a prior art center drive device.

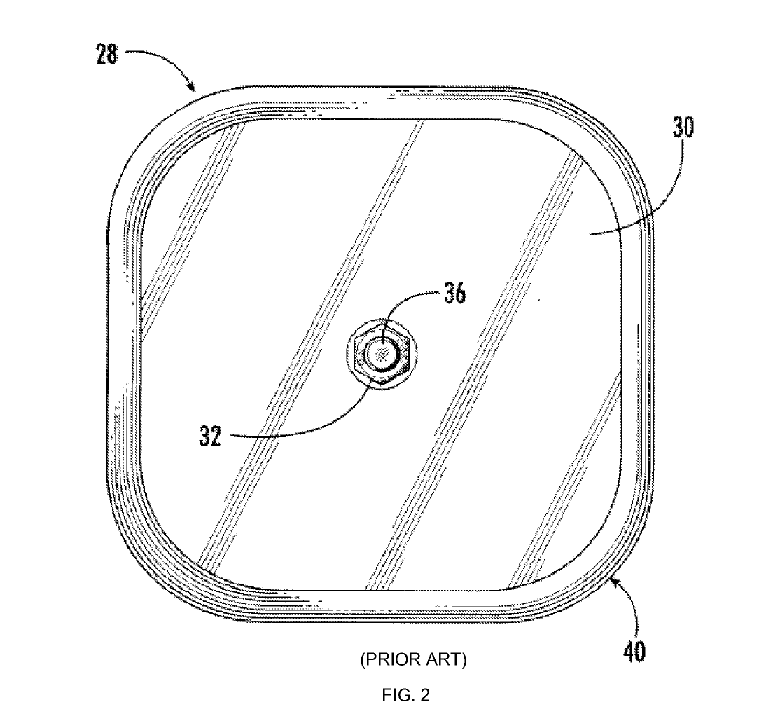

FIG. 3 is a top view of an exemplary side reel adaptor, in accordance with various embodiments.

FIG. 4 is a side view of an exemplary side reel adaptor, in accordance with various embodiments.

FIG. 5 is a drawing of an exemplary side reel adaptor attached to a conventional fish tape reel, in accordance with various embodiments.

FIG. 6 is a perspective view of a side reel adaptor for a fish tape reel that allows the fish tape reel to be spun with a drill and that uses an attachment plate, in accordance with various embodiments.

FIG. 7 is a perspective view of a side reel adaptor that uses an attachment plate showing that the central bit can be detached for packaging or storage, in accordance with various embodiments.

FIG. 8 is a perspective view of a side reel adaptor that uses an attachment plate showing that the attachment plate can include a hinge that allows the central bit to be folded parallel to the attachment plate for packaging or storage, in accordance with various embodiments.

FIG. 9 is a perspective view of a side reel adaptor that includes two attachment plates, in accordance with various embodiments.

FIG. 10 is a perspective view of a side reel adaptor for a fish tape reel that allows the fish tape reel to be spun with a drill and that uses one or more attachment spokes, in accordance with various embodiments.

FIG. 11 is a perspective view of a side reel adaptor that uses one or more attachment spokes showing that the central bit can be detached for packaging or storage, in accordance with various embodiments.

FIG. 12 is a perspective view of a side reel adaptor that uses one or more attachment spokes showing that the one or more attachment spokes can include a hinge that allows the central bit to be folded parallel to the one or more attachment spokes for packaging or storage, in accordance with various embodiments.

FIG. 13 is a perspective view of a side reel adaptor that includes a second set of one or more attachment spokes, in accordance with various embodiments.

Before one or more embodiments of the invention are described in detail, one skilled in the art will appreciate that the invention is not limited in its application to the details of construction, the arrangements of components, and the arrangement of steps set forth in the following detailed description. The invention is capable of other embodiments and of being practiced or being carried out in various ways. Also, it is to be understood that the phraseology and terminology used herein is for the purpose of description and should not be regarded as limiting.

### DETAILED DESCRIPTION

### Side Reel Adaptor

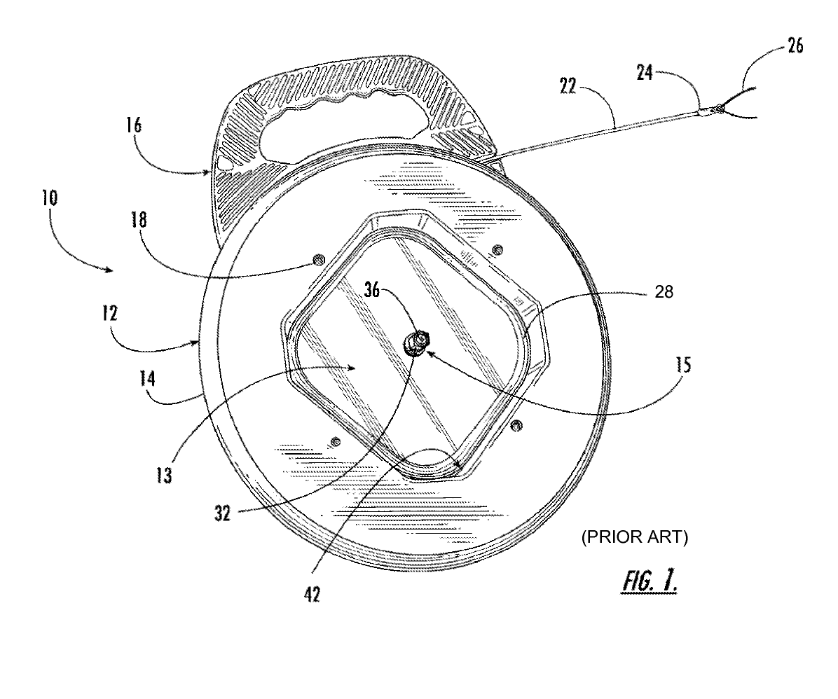

As described above, the device described by Yates has at least four problems. First, the attachment embodiment appears difficult to secure and, as described above, is likely to wobble under higher speeds and continued use. Second, the center drive device 28 of FIG. 1 completely fills central opening 13, preluding its use in manual retraction. Third, a different center drive device 28 has to be used for each different type and size of fish tape reel, since the central opening 13 varies among types and sizes of fish tape reels. Four, integrally forming center drive device 28 requires modification of existing reels.

In various embodiments, a side reel adaptor provides a secure attachment for existing fish tape reels, allows the central opening of existing fish tape reels to be used manual retraction, and requires no modification to existing fish tape reels.

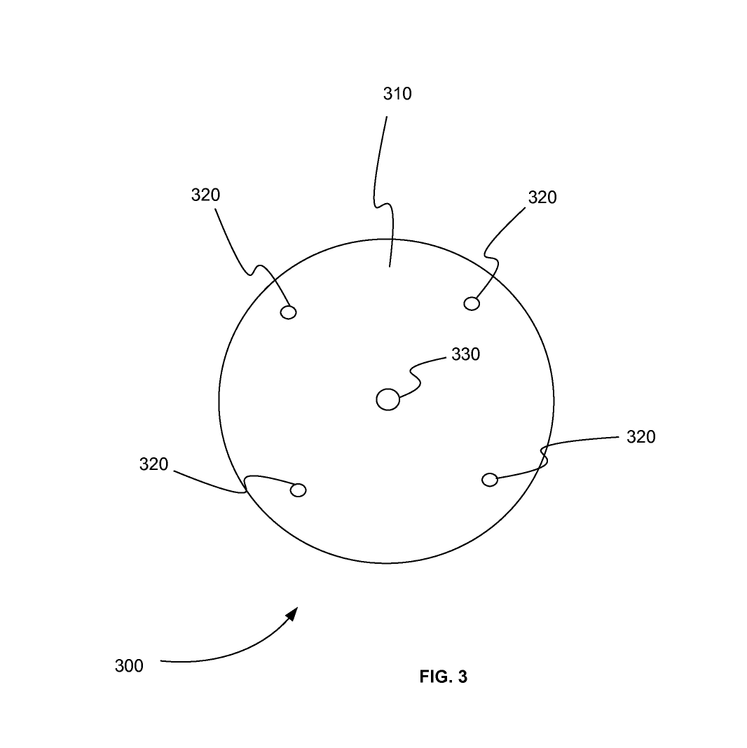

FIG. 3 is a top view 300 of an exemplary side reel adaptor 310, in accordance with various embodiments. Side reel adaptor 310 is a plate that includes holes 320 and center bit attachment 330. As shown in FIG. 3 the plate is circular. However, the plate can be any shape. The plate can also be made of any rigid material including, but not limited to, metal, plastic, Plexiglas, or, wood. In various embodiments, side reel adaptor 310 does not have to be a solid plate. Side reel adaptor 310, for example, can be a spoked plate.

Side reel adaptor 310 includes holes 320 for attachment to any conventional fish tape reel. As described above with reference to FIG. 1, fish tape reels include screws 18 to hold together ring-shaped members of the reels. Side reel adaptor 310 in FIG. 3 includes holes 320 aligned with these screws. Side reel adaptor 310 is then attached to a conventional reel by removing the screws of the conventional reel, aligning the holes of the reel and holes 320, and screwing the screws back into the reel through holes 320. FIG. 3 shows four holes 320 in side reel adaptor 310. However, side reel adaptor 310 can have many holes aligned for many different types and sizes of fish tape reels. Also, conventional fish tape reels typically have three or four screws, but can have any number of screws. Consequently, side reel adaptor is not limited to three or four holes.

Side reel adaptor 310 also includes center bit attachment 330. Center bit attachment 330 is an attachment in the center of side reel adaptor 310 that extends a bit or rod perpendicular from the center of side reel adaptor 310. When side reel adaptor 310 is attached to a fish tape reel, center bit attachment 330 is designed to extend through the center of the fish tape reel and to accept a drill chuck on the other side of the fish tape reel. Center bit attachment 330 is, therefore, used to spin side reel adaptor and, in turn, the portion of the fish tape reel to which it is attached.

Center bit attachment 330 can be connected to side reel adaptor 310 in a number of ways. For example, center bit attachment 330 can be fixed in place perpendicular to side reel adaptor 310. In another embodiment, center bit attachment 330 can be removable or detachable from side reel adaptor 310. Center bit attachment 330 is removable for packaging or storage, for example. In still another embodiment, center bit attachment 330 is connected to side reel adaptor 310 in such a fashion that it can be folded to a position parallel to side reel adaptor 310 for easy packaging or storage.

Center bit attachment 330 preferably extends through the center of the fish tape reel and accepts a drill chuck on the other side of the fish tape reel. However, in alternative embodiments, center bit attachment 330 can extend away from the fish tape reel and accept a drill chuck on the same side of the fish tape reel as the side reel adaptor.

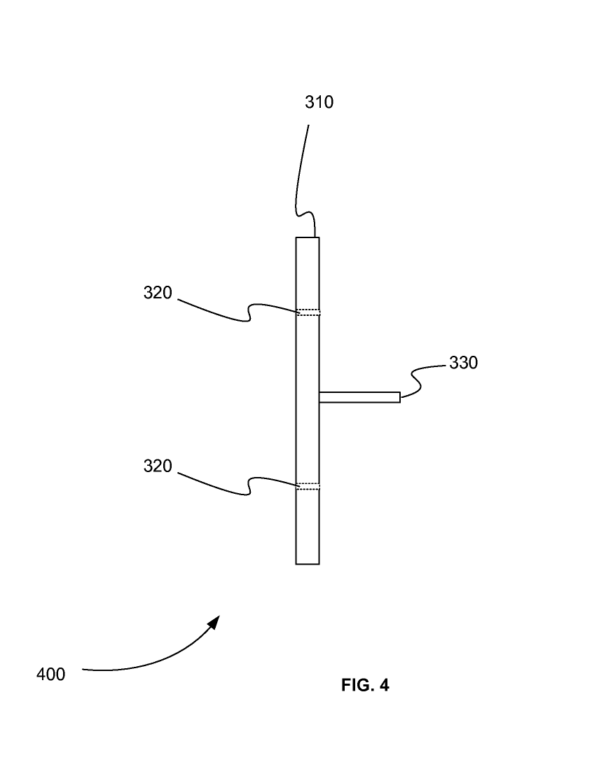

FIG. 4 is a side view 400 of an exemplary side reel adaptor 310, in accordance with various embodiments. FIG. 4 shows that center bit attachment 330 is extended perpendicular from the side reel adaptor 310. FIG. 4 also shows that holes 320 extend through side reel adaptor 310. Center bit attachment 330 is shown in FIG. 4 as being formed from or welded to side reel adaptor 310. In various alternative embodiments, center bit attachment 330 is a bolt extending through a keyed hole in side reel adaptor 310. The holed is keyed, for example, to prevent the bolt from spinning with respect to side reel adaptor 310. The bolt also can simply be secured to side reel adaptor by a nut, for example.

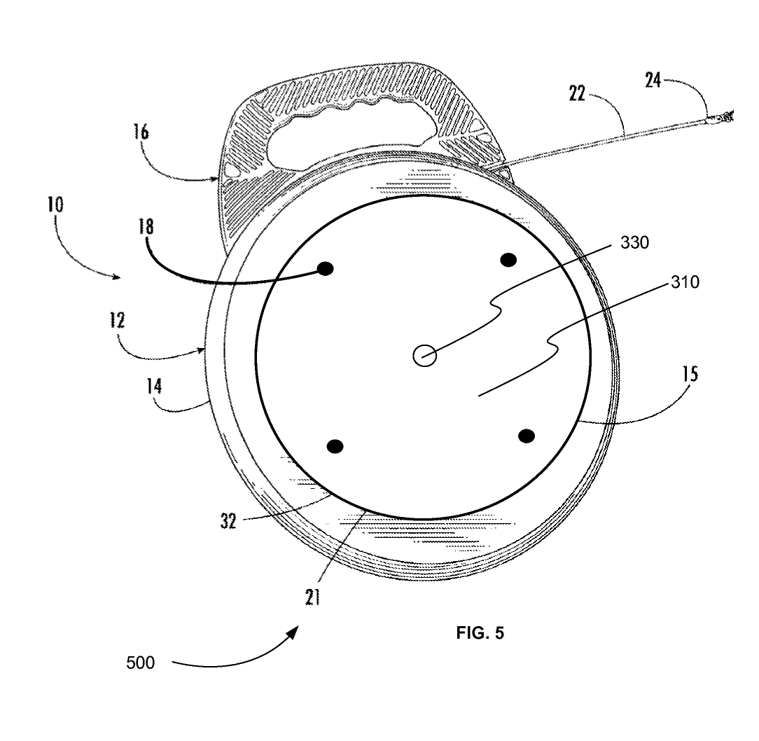

FIG. 5 is a drawing 500 of an exemplary side reel adaptor 310 attached to a conventional fish tape reel 10, in accordance with various embodiments. Side reel adaptor 310 is secured to a conventional fish tape reel 10 using screws 18 of fish tape reel 10. When a drill chuck of a drill is attached to center bit attachment 330 on either side of fish tape reel 10, the drill can spin side reel adaptor 310 and, in turn, reel housing 12 with respect to handle 16. Depending on the spin direction, fish tape 22 is either let out or retracted from reel 10.

By attaching a side reel adaptor to a single side of a fish tape reel, the opening of the center of the fish tape reel is available for use in manual retraction. However, in various embodiments, the side reel adaptor can include two plates attached on either side of the fish tape reel, so that the side reel adaptor can be attached more securely to the fish tape reel.

### Side Reel Adapter Using a Plate

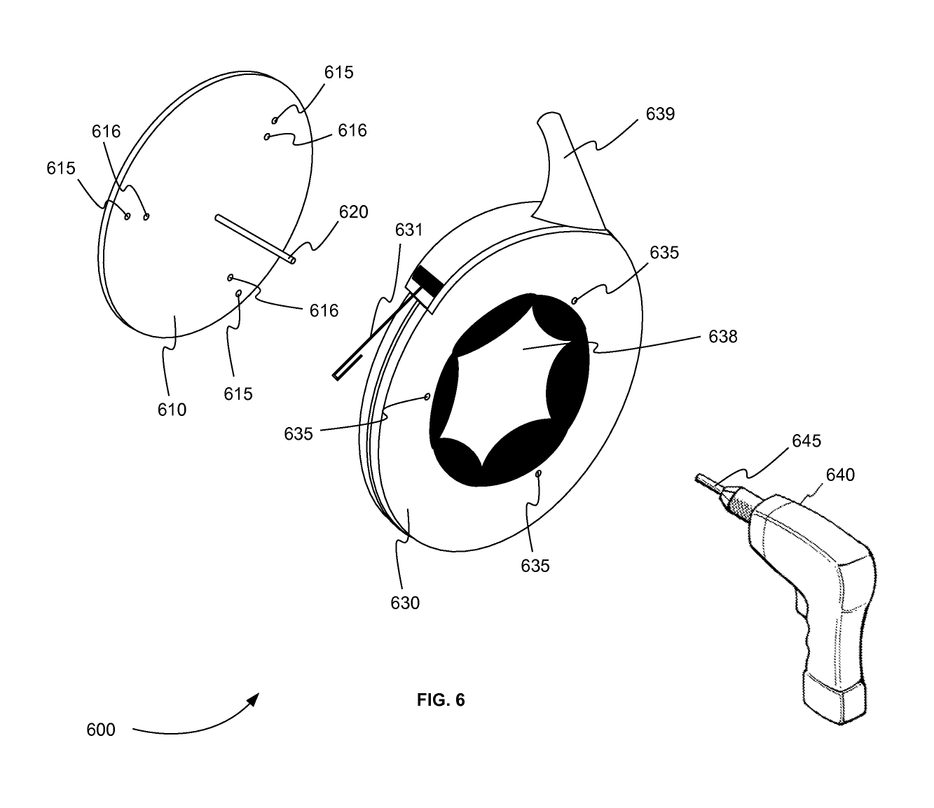

FIG. 6 is a perspective view 600 of a side reel adaptor for a fish tape reel that allows the fish tape reel to be spun with a drill and that uses an attachment plate, in accordance with various embodiments. The side reel adapter includes attachment plate 610 and central bit 620. Attachment plate 610 includes a plurality of holes that are aligned with the screw holes of one or more fish tape reels so that attachment plate 610 can be attached to the side of the one or more fish tape reels using the screws of the one or more fish tape reels. For example, attachment plate 610 includes holes 615 that are aligned with screw holes 635 of fish tape reel 630. Attachment plate 610 also, however, includes holes 616. Holes 616 are aligned, for example, with screw holes of a different model fish tape reel (not shown). Attachment plate 610 can be a flat plate, a convex plate, or a concave plate, for example.

Central bit 620 is connected to the center of attachment plate 610 so that central bit 620 is perpendicular to attachment plate 610. Central bit 620 is adapted to accept a drill chuck so that a drill can spin attachment plate 610 about the axis of central bit 620 and, in turn, spin a portion of a fish tape reel attached to attachment plate 610. For example, central bit 620 is formed to fit into the drill chuck of a standard drill, such as drill chuck 645 of drill 640. Central bit 620 is, for example, a metal rod. Central bit 620 may also be formed to have a cross-sectional shape on one end or across the entire length that is not round in order to be held in the drill chuck more securely. For example, central bit 620 may also be formed to have a cross-sectional rectangular or hexagonal shape on one end or across the entire length in order to be held in the drill chuck more securely.

In order to attach attachment plate 610 to fish tape reel 630, for example, the screws in screw holes 635 of fish tape reel 630 are removed. Attachment plate 610 is placed against the side of fish tape reel 630 not shown so that central bit 620 protrudes through the hollow center 638 of fish tape reel 630. Attachment plate 610 is then rotated or shifted to align holes 615 of attachment plate 610 with holes 635 of fish tape reel 630. After alignment, the screws previously removed are placed through holes 615 and into holes 635 to secure attachment plate 610 to the side of fish tape reel 630.

In order to spin the portion of fish tape reel 630 attached to attachment plate 610 with respect to the portion of fish tape reel 630 connected to handle 639, chuck 645 of drill 640 is secured to central bit 620. By holding drill 640 and handle 639 and pressing the trigger of drill 640, fish tape 631 of fish tape reel 630 is either reeled in or reeled out using the power of drill 640.

In various embodiments, central bit 620 is permanently attached to the center of attachment plate 610. For example, central bit 620 is welded to the center of attachment plate 610.

In various embodiments, central bit 620 is connected to the center of attachment plate 610 using a means that allows central bit 620 to be detached from attachment plate 610 for packaging or storage.

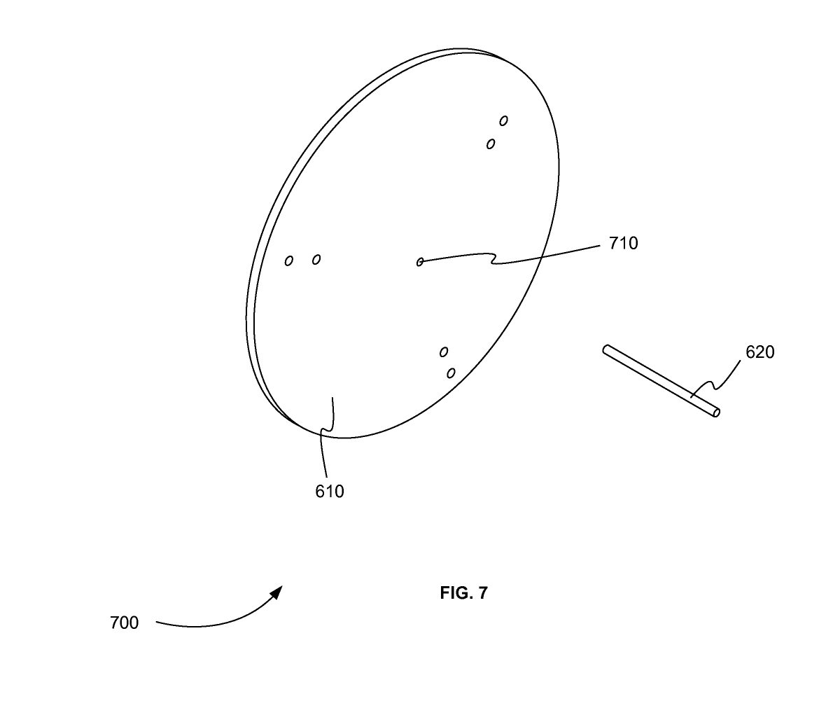

FIG. 7 is a perspective view 700 of a side reel adaptor that uses an attachment plate showing that the central bit can be detached for packaging or storage, in accordance with various embodiments. Various means can be used that allow central bit 620 to be detached from attachment plate 610 for packaging or storage. For example, central bit 620 can include threads on one end and can be screwed into threaded hole at location 710 of attachment plate 610. In an alternative example, central bit 620 can include threads on one end, be placed through non-threaded hole at location 710 of attachment plate 610, and bolted to attachment plate 610 using one or more nuts (not shown).

In various embodiments, means that allow central bit 620 to be detached from attachment plate 610 for packaging or storage can include a bit or socket extender. For example, location 710 can include a permanently placed shortened bit or a male socket adaptor. Central bit 620 is then a bit extender that attaches to the shortened bit at location 710 or a socket extender that attached to the male socket adaptor at location 710. The central bit extender 620 can be secured to the shortened bit using an Allen screw or other type of screw. Similarly, the central bit socket extender 620 can be secured to the male socket adaptor using an Allen screw or other type of screw.

In various embodiments, central bit 620 is connected to the center of attachment plate 610 using a hinge that allows central bit 620 to be folded parallel to attachment plate 610 for packaging or storage.

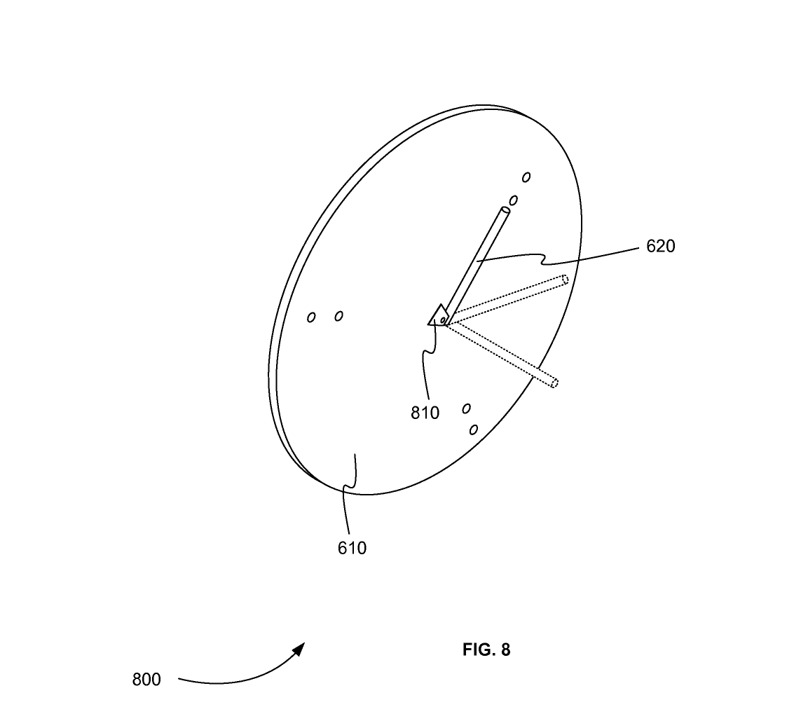

FIG. 8 is a perspective view 800 of a side reel adaptor that uses an attachment plate showing that the attachment plate can include a hinge that allows the central bit to be folded parallel to the attachment plate for packaging or storage, in accordance with various embodiments. For example, hinge 810 of attachment plate 610 allows central bit 620 to be folded from a position perpendicular to attachment plate 610 to a position parallel to attachment plate 610. Hinge 810 can also include a lock to lock central bit 620 into either position.

In various embodiments, attachment plate 610 can be made of a variety of materials including, but not limited to, metal, plastic, Plexiglas, fiberglass, or wood.

In various embodiments, for greater stability, the fish tape reel adaptor can include a second attachment plate.

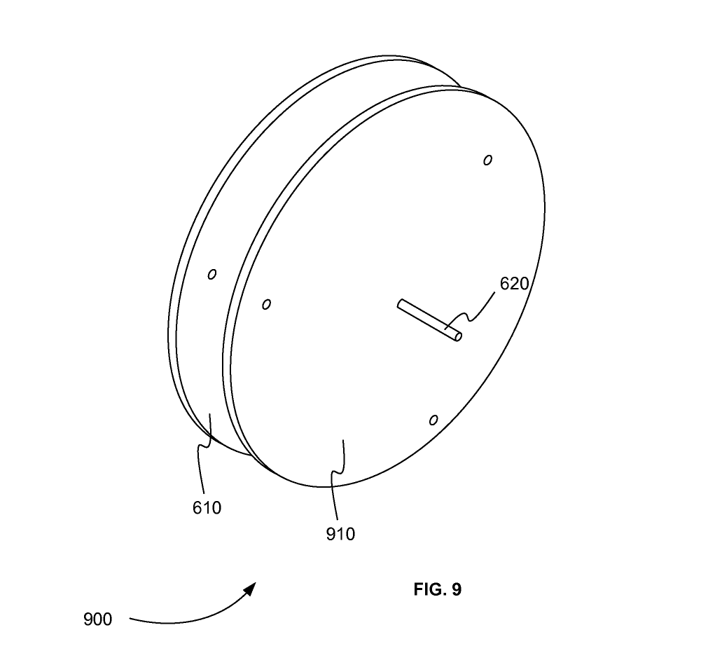

FIG. 9 is a perspective view 900 of a side reel adaptor that includes two attachment plates, in accordance with various embodiments. Like first attachment plate 610, second attachment plate 910 includes a plurality of holes that are aligned with the screw holes of one or more fish tape reels so that second attachment plate 910 can be attached to the other side of the one or more fish tape reels using the screws of the one or more fish tape reels. Central bit 620 is also attached to the center of second attachment plate 910 so that central bit 620 is perpendicular to second attachment plate 910. A drill can also spin second attachment plate 910 about the axis of central bit 620 and, in turn, spin the portion of the fish tape reel also attached to second attachment plate 910. In other words, the two attachment plates 610 and 910 are attached to the sides of a fish tape reel to spin that portion of the fish tape reel connected to the sides.

In various embodiments, additional longer screws or bolts and nuts are provided for each of the one or more fish tape reels in order to allow two attachment plates 610 and 910 to be secured to each of the one or more fish tape reels. In other words longer screws are needed to secure two attachment plates to a fish tape reel.

### Side Reel Adapter Using One or More Attachment Spokes

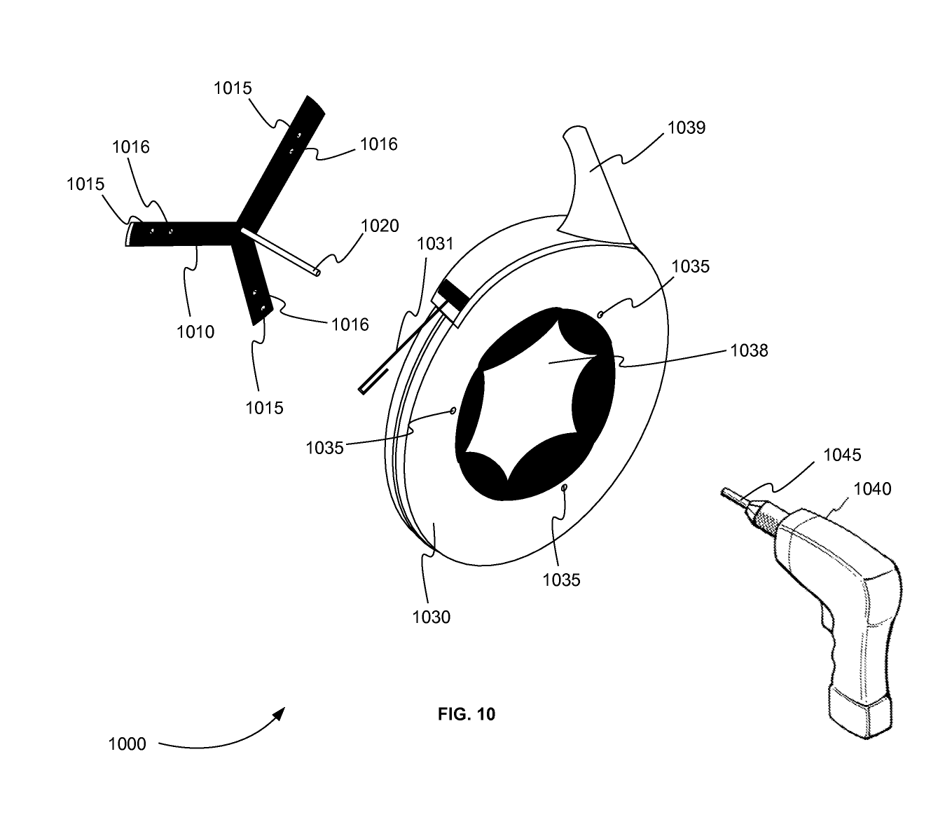

FIG. 10 is a perspective view 1000 of a side reel adaptor for a fish tape reel that allows the fish tape reel to be spun with a drill and that uses one or more attachment spokes, in accordance with various embodiments. The side reel adapter includes one or more attachment spokes 1010 and central bit 1020. One or more attachment spokes 1010 include a plurality of holes that are aligned with the screw holes of one or more fish tape reels so that one or more attachment spokes 1010 can be attached to the side of the one or more fish tape reels using the screws of the one or more fish tape reels. For example, one or more attachment spokes 1010 include holes 1015 that are aligned with screw holes 1035 of fish tape reel 1030. One or more attachment spokes 1010 also, however, include holes 1016. Holes 1016 are aligned, for example, with screw holes of a different model fish tape reel (not shown). One or more attachment spokes 1010 can be flat, convex, or concave, for example.

Central bit 1020 is connected to the center of one or more attachment spokes 1010 so that central bit 1020 is perpendicular to one or more attachment spokes 1010. Central bit 1020 is adapted to accept a drill chuck so that a drill can spin one or more attachment spokes 1010 about the axis of central bit 1020 and, in turn, spin a portion of a fish tape reel attached to one or more attachment spokes 1010. For example, central bit 1020 is formed to fit into the drill chuck of a standard drill, such as drill chuck 1045 of drill 1040. Central bit 1020 is, for example, a metal rod.

In order to attach one or more attachment spokes 1010 to fish tape reel 1030, for example, the screws in screw holes 1035 of fish tape reel 1030 are removed. One or more attachment spokes 1010 are placed against the side of fish tape reel 1030 not shown so that central bit 1020 protrudes through the hollow center 1038 of fish tape reel 1030. One or more attachment spokes 1010 are then rotated or shifted to align holes 1015 of one or more attachment spokes 1010 with holes 1035 of fish tape reel 1030. After alignment, the screws previously removed are placed through holes 1015 and into holes 1035 to secure one or more attachment spokes 1010 to the side of fish tape reel 1030.

In order to spin the portion of fish tape reel 630 attached to one or more attachment spokes 1010 with respect to the portion of fish tape reel 1030 connected to handle 1039, chuck 1045 of drill 1040 is secured to central bit 1020. By holding drill 1040 and handle 1039 and pressing the trigger of drill 1040, fish tape 1031 of fish tape reel 1030 is either reeled in or reeled out using the power of drill 1040.

In various embodiments, central bit 1020 is permanently attached to the center of one or more attachment spokes 1010. For example, central bit 1020 is welded to the center of one or more attachment spokes 1010.

In various embodiments, central bit 1020 is connected to the center of one or more attachment spokes 1010 using a means that allows central bit 1020 to be detached from one or more attachment spokes 1010 for packaging or storage.

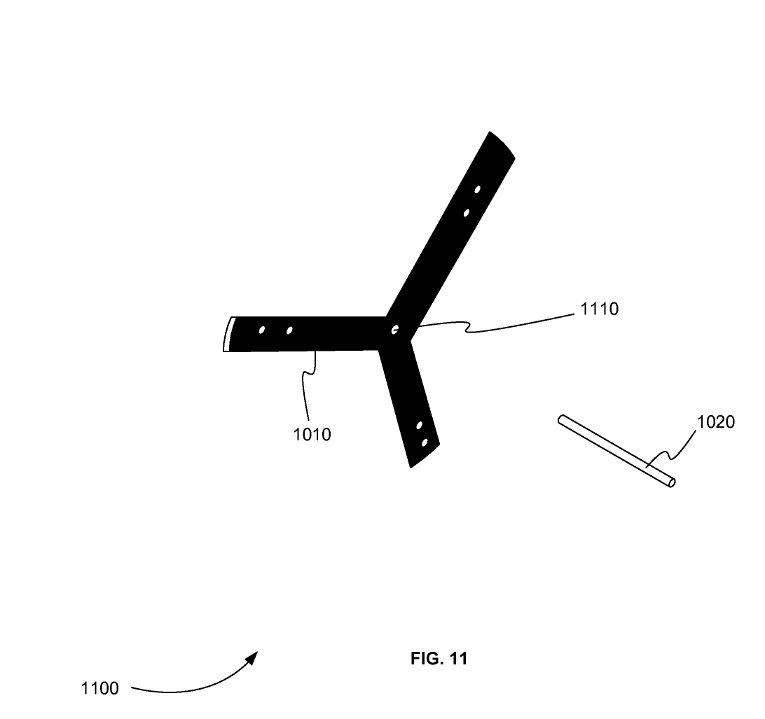

FIG. 11 is a perspective view 1100 of a side reel adaptor that uses one or more attachment spokes showing that the central bit can be detached for packaging or storage, in accordance with various embodiments. Various means can be used that allow central bit 1020 to be detached from one or more attachment spokes 1010 for packaging or storage. For example, central bit 1020 can include threads on one end and can be screwed into threaded hole at location 1110 of one or more attachment spokes 1010. In an alternative example, central bit 1020 can include threads on one end, be placed through non-threaded hole at location 1110 of one or more attachment spokes 1010, and bolted to one or more attachment spokes 1010 using one or more nuts (not shown).

In various embodiments, means that allow central bit 1020 to be detached from one or more attachment spokes 1010 for packaging or storage can include a bit or socket extender. For example, location 1110 can include a permanently placed shortened bit or a male socket adaptor. Central bit 1020 is then a bit extender that attaches to the shortened bit at location 1110 or a socket extender that attached to the male socket adaptor at location 1110. The central bit extender 1020 can be secured to the shortened bit using an Allen screw or other type of screw. Similarly, the central bit socket extender 1020 can be secured to the male socket adaptor using an Allen screw or other type of screw.

In various embodiments, central bit 1020 is connected to the center of one or more attachment spokes 1010 using a hinge that allows central bit 1020 to be folded parallel to one or more attachment spokes 1010 for packaging or storage.

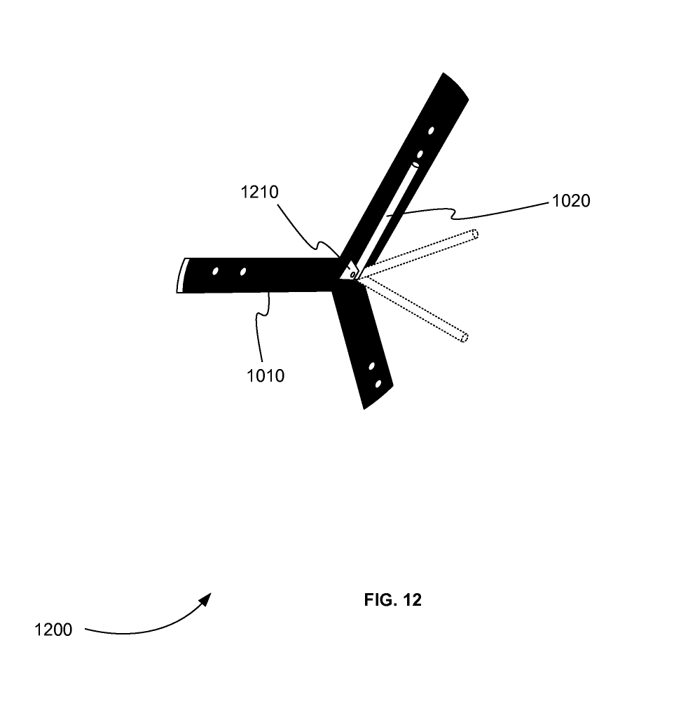

FIG. 12 is a perspective view 1200 of a side reel adaptor that uses one or more attachment spokes showing that the one or more attachment spokes can include a hinge that allows the central bit to be folded parallel to the one or more attachment spokes for packaging or storage, in accordance with various embodiments. For example, hinge 1210 of one or more attachment spokes 1010 allows central bit 1020 to be folded from a position perpendicular to one or more attachment spokes 1010 to a position parallel to one or more attachment spokes 1010. Hinge 1210 can also include a lock to lock central bit 1020 into either position.

In various embodiments, one or more attachment spokes 1010 can be made of a variety of materials including, but not limited to, metal, plastic, Plexiglas, fiberglass, or wood.

In various embodiments, for greater stability, the fish tape reel adaptor can include a second set of one or more attachment spokes.

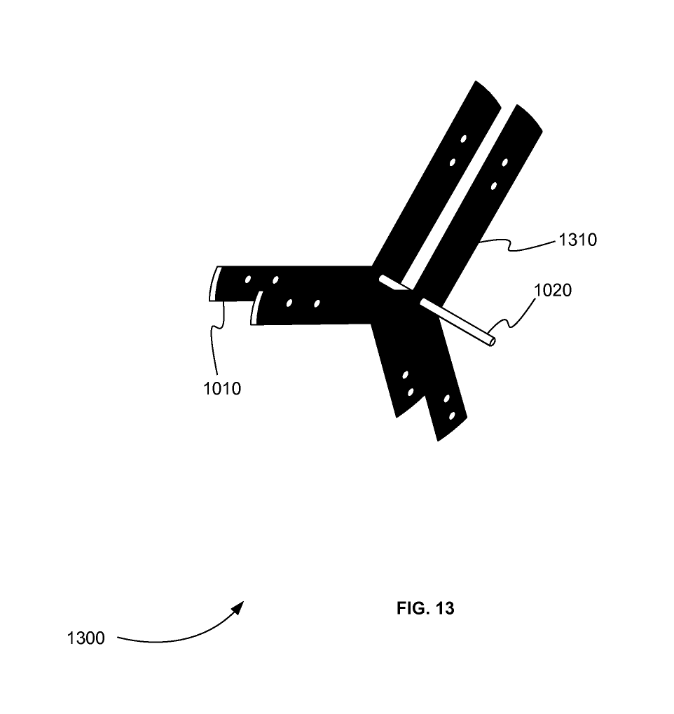

FIG. 13 is a perspective view 1300 of a side reel adaptor that includes a second set of one or more attachment spokes, in accordance with various embodiments. Like first set of one or more attachment spokes 1010, second set of one or more attachment spokes 1310 includes a plurality of holes that are aligned with the screw holes of one or more fish tape reels so that second set of one or more attachment spokes 1310 can be attached to the other side of the one or more fish tape reels using the screws of the one or more fish tape reels. Central bit 1020 is also attached to the center of second set of one or more attachment spokes 1310 so that central bit 1020 is perpendicular to second set of one or more attachment spokes 1310. A drill can also spin second set of one or more attachment spokes 1310 about the axis of central bit 1020 and, in turn, spin the portion of the fish tape reel also attached to second set of one or more attachment spokes 1310. In other words, the two sets of one or more attachment spokes 1010 and 1310 are attached to the sides of a fish tape reel to spin that portion of the fish tape reel connected to the sides.

In various embodiments, additional longer screws or bolts and nuts are provided for each of the one or more fish tape reels in order to allow two sets of one or more attachment spokes 1010 and 1310 to be secured to each of the one or more fish tape reels. In other words longer screws are needed to secure two sets of one or more attachment spokes to a fish tape reel.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A side reel adaptor for a fish tape reel that allows the fish tape reel to be spun with a drill and that uses an attachment plate, comprising:
an attachment plate that includes a plurality of holes that are aligned with the screw holes of one or more fish tape reels so that the attachment plate can be attached to the side of the one or more fish tape reels using the screws of the one or more fish tape reels; and
a central bit connected to the center of the attachment plate so that the central bit is perpendicular to the attachment plate, wherein the central bit is adapted to accept a drill chuck so that a drill can spin the attachment plate about the axis of the central bit and, in turn, spin a portion of a fish tape reel attached to the attachment plate.

2. The fish tape reel adaptor of claim 1, wherein the central bit is permanently attached to the center of the attachment plate.

3. The fish tape reel adaptor of claim 1, wherein the central bit is connected to the center of the attachment plate using a means that allows the central bit to be detached for packaging or storage.

4. The fish tape reel adaptor of claim 1, wherein the central bit is connected to the center of the attachment plate using a hinge that allows the central bit to be folded parallel to the attachment plate for packaging or storage.

5. The fish tape reel adaptor of claim 1, wherein the attachment plate comprises a metal attachment plate.

6. The fish tape reel adaptor of claim 1, wherein the attachment plate comprises a plastic attachment plate.

7. The fish tape reel adaptor of claim 1, wherein the attachment plate comprises a Plexiglas attachment plate.

8. The fish tape reel adaptor of claim 1, wherein the attachment plate comprises a wooden attachment plate.

9. The fish tape reel adaptor of claim 1, wherein the attachment plate comprises a fiberglass attachment plate.

10. The fish tape reel adaptor of claim 1, further comprising a second attachment plate that includes a plurality of holes that are aligned with the screw holes of one or more fish tape reels so that the second attachment plate can be attached to the other side of the one or more fish tape reels using the screws of the one or more fish tape reels, wherein central bit is also attached to the center of the second attachment plate so that the central bit is perpendicular to the second attachment plate and wherein the drill can also spin the second attachment plate about the axis of the central bit and, in turn, spin the portion of the fish tape reel also attached to the second attachment plate.

11. A side reel adaptor for a fish tape reel that allows the fish tape reel to be spun with a drill and that uses one or more attachment spokes, comprising:
one or more attachment spokes connected at a center that include one or more holes that are aligned with the screw holes of one or more fish tape reels so that the one or more attachment spokes can be attached to the side of the one or more fish tape reels using the screws of the one or more fish tape reels; and
a central bit connected to the center of the one or more attachment spokes so that the central bit is perpendicular to the one or more attachment spokes, wherein the central bit is adapted to accept a drill chuck so that a drill can spin the one or more attachment spokes about the axis of the central bit and, in turn, spin a portion of a fish tape reel attached to the one or more attachment spokes.

12. The fish tape reel adaptor of claim 11, wherein the central bit is permanently attached to the center of the one or more attachment spokes.

13. The fish tape reel adaptor of claim 11, wherein the central bit is connected to the center of the one or more attachment spokes center using a means that allows the central bit to be detached for packaging or storage.

14. The fish tape reel adaptor of claim 11, wherein the central bit is connected to the center of the one or more attachment spokes using a hinge that allows the central bit to be folded parallel to the one or more attachment spokes for packaging or storage.

15. The fish tape reel adaptor of claim 11, wherein the one or more attachment spokes comprise one or more metal attachment spokes.

16. The fish tape reel adaptor of claim 11, wherein the one or more attachment spokes comprise one or more plastic attachment spokes.

17. The fish tape reel adaptor of claim 11, wherein the one or more attachment spokes comprise one or more Plexiglas attachment spokes.

18. The fish tape reel adaptor of claim 11, wherein the one or more attachment spokes comprise one or more wooden attachment spokes.

19. The fish tape reel adaptor of claim 11, wherein the one or more attachment spokes comprise one or more fiberglass attachment spokes.

20. The fish tape reel adaptor of claim 11, further comprising a second set of one or more attachment spokes connected at a center that includes a plurality of holes that are aligned with the screw holes of one or more fish tape reels so that the second set of one or more attachment spokes can be attached to the other side of the one or more fish tape reels using the screws of the one or more fish tape reels, wherein the central bit is also attached to the center of the second set of one or more attachment spokes so that the central bit is perpendicular to the second set of one or more attachment spokes and wherein the drill can also spin the second set of one or more attachment spokes about the axis of the central bit and, in turn, spin the portion of the fish tape reel also attached to the second set of one or more attachment spokes.
